(19) United States
(12) Patent Application Publication
(10) Pub. No.: US 2013/0325877 A1
(43) Pub. Date: Dec. 5, 2013

(54) Uses Of Root Cause Analysis, Systems And Methods

(71) Applicant: Razieh Niazi, New York (CA)

(72) Inventor: Razieh Niazi, New York (CA)

(21) Appl. No.: 13/907,289

(22) Filed: May 31, 2013

Related U.S. Application Data
(60) Provisional application No. 61/653,641, filed on May 31, 2012.
(60) Provisional application No. 61/661,014, filed on Jun. 18, 2012.

(51) Int. Cl. G06F 17/30

(52) U.S. Cl. CPC G06F 17/30011
USPC 707/748; 707/736

(57) ABSTRACT

Sentiment-based and root cause-based analysis and recommendation engines are presented. The engines are preferably capable of leveraging a sentiment root cause for multiple purposes including integration with CRM applications, guiding search results, or recommending changes to documents.

This application claims the benefit of priority to U.S. provisional application 61/653,641 filed May 31, 2012, and U.S. provisional application 61/661,014 filed Jun. 18, 2012. These and all publications herein are incorporated by reference to the same extent as if each individual publication or patent application were specifically and individually indicated to be incorporated by reference.

### FIELD OF THE INVENTION

The field of the invention is root cause analysis technologies.

### BACKGROUND

Much effort has been directed to analyzing on-line content to derive a sentiment related to the content. Unfortunately, the validity of such sentiment analyses remains suspect as there are no known techniques to validate an analysis. Example effort includes U.S. patent application publication 2010/0070276 to Wasserblat et al. titled “Method and Apparatus for Interaction or Discourse Analytics”, filed Sep. 16, 2008. Wasserblat contemplates extracting acoustic or text features from call center interactions where the features can be classified by sentiment type. Wasserblat fails to provide insight into the causes for the sentiment in the first place.

Other examples include U.S. patent application publication 2010/0161640 to Mintz et al. titled “Apparatus and Method for Multimedia Content Based Manipulation”, filed Dec. 23, 2008; and U.S. patent application publication 2011/0208522 to Pereg et al. titled “Method and Apparatus for Detection of Sentiment in Automated Transcripts”. Mintz indicates that one could conduct an advance analysis that includes root cause analysis where the advanced analysis contributes to construction of ontology. Pereg indicates that a root causes analysis can be applied to sentimental areas of call center interactions to determent a root cause of a problem that gave rise to an a call center event.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Interestingly, although some of the above references mention root causes analysis per se, they fail to appreciate that a sentiment itself can have a root cause representing a driver for the sentiment. The Applicant has appreciated that a sentiment root cause can be derived from documents on which a sentiment analysis was conducted and can be leveraged as valuable, marketable commodity across multiple markets.

Thus, there is still a need for systems capable of generating sentiment root cause and leveraging root cause in document search technologies and document generation technologies.

### SUMMARY OF THE INVENTION

The inventive subject matter provides apparatus, systems and methods in which one can leverage root cause of a sentiment for various purposes. One aspect of the inventive subject matter includes a root cause analysis system comprising a document interface and a root cause analysis engine. The document interface can be configured to access a corpus of documents where each document includes document elements (e.g., words, phrases, normalized concepts, topics, sentences, metadata, etc.). In some embodiments, the corpus of documents can include a database of records, blocks of text, a plurality of web sites, a file system, or even a distributed database. The root cause analysis engine can be configured to obtain one or more sentiments, possibly bound to the documents or via a sentiment analysis engine, associated with the documents individually or collectively. The sentiment can be derived according to numerous possible techniques. The analysis engine can then analyze elements within the document with respect to associated sentiments to generate at least one root cause of the sentiments. When appropriate, the analysis engine can configure an output device (e.g., browser, printer, cell phone, computer, etc.) to present the root causes.

Another aspect of the inventive subject matter is considered to include search engines capable of providing search results as indexed by sentiment or root cause for the sentiment. In some scenarios, the search engine can be configured as a crawler capable of tracking down documents based on sentiment within the documents or root causes for the sentiments as found in the documents. One embodiment of the search engine includes a database of searchable documents (e.g., web pages, metadata, text documents, audio files, video files, image files, etc.). A sentiment analysis engine within the search engine can derive sentiment related to one or more of the documents according to one or more topics associated with the topic. The sentiment engine can then index the documents according to the sentiment, possibly according to a sentiment-based indexing scheme. For example, the sentiment-based or emotion-based indexing scheme can represent topics, possibly hierarchically or by classification, along with corresponding sentiments (e.g., positive, neutral, negative, etc.) associated with the topics. The search engine can further comprise a search interface through which search results can be presented in response to a sentiment-based query submitted to the search engine. Similarly, a search engine could also include a root cause analysis engine capable of deriving a root cause associated with sentiments. In such a scenarios, the root cause analysis engine can index documents according to a root cause indexing scheme allowing searchers to find documents having sentiment drivers representing root causes. One should appreciate the root cause indexing scheme can be based on an associated topic or even a derived concept; a “fee”, for example, for a banking service.

Yet another aspect of the inventive subject matter is considered to include a sentiment-based recommendation system. Contemplated recommendation systems can include a sentiment database storing sentiment objects, possibly documents, where the sentiment objects represent a possible sentiment for a topic and could also include possible root causes for the sentiment. A recommendation engine can receive a target document from a user, possibly via a web page or through a word processing device. The recommendation engine is further configured to identify a topic associated with the target document. The recommendation engine can then use the topic to identify sentiment objects that might be relevant to the target document, regardless if the relevancy is based on sentiment having a positive, negative, neutral, or other value. The recommendation engine can then use the sentiment drivers or other root causes to offer recommendations on changes to the target document so that the target document comprises, directly or indirectly, the drivers for the desired sentiment. The recommendations could include suggestions, edits, modifications, highlights, or other indications of how the target document could be modified to incorporate a sentiment driver.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a sentiment root cause analysis system.

FIG. 2 is a schematic of a search engine capable of searching for documents indexed by root cause or sentiment.

FIG. 3 is a schematic of a recommendation engine that recommends incorporating sentiment drivers into a target document.

### DETAILED DESCRIPTION

It should be noted that while the following description is drawn to a computer/server-based sentiment or root causes analysis systems, various alternative configurations are also deemed suitable and may employ various computing devices including servers, interfaces, systems, databases, agents, peers, engines, controllers, or other types of computing devices operating individually or collectively. One should appreciate that use of such terms are deemed to represent computing devices that comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet-switched network.

One should appreciate that the disclosed techniques provide many advantageous technical effects including generating sentiment or root cause signals capable of configuring devices to present sentiment analysis results. Such signals can be used to retrieve search documents, providing insight into a root cause for a sentiment, configure a device to present recommendations on changes to target documents, or other purposes.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within this document, the terms “coupled to” and “coupled with” are also euphemistically used to mean “communicatively coupled with” where two or more networked devices are able to exchange data over a network, possibly via one or more intermediary devices.

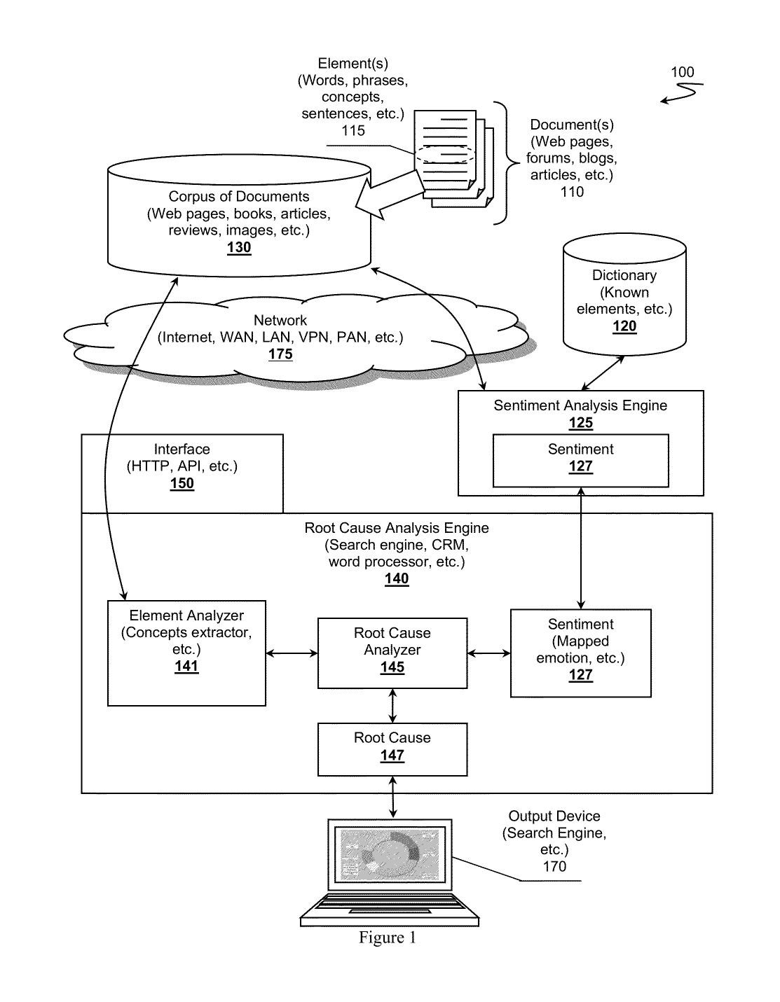

FIG. 1 illustrates an ecosystem that operates as root cause analysis system 100. Root cause analysis system 100 preferably operates to find one or more root causes 147 for sentiment 127 or concept related to a topic in one or more documents 110. In the example shown, root cause analysis system 100 comprises root cause analysis engine 140 and corpus 130 of documents 110.

Corpus 130 can include a compilation of one or more documents 110, possibly of different types, related to a topic on which a sentiment analysis is run. Examples of documents 110 preferably include digital documents comprising text. However, all digital documents are contemplated. For example, audio documents, image documents, video documents, or other types of documents 110 can have their content converted to an appropriate modality for analysis. Image documents can be preprocessed by optical character recognition algorithms (OCR) to derive text, while audio documents can be preprocessed by automatic speech recognition algorithm (ASR) to derive words within the documents. Video documents could be preprocessed by both OCR and ASR to generate content within such documents. The analysis discussed below can then be run based on the derived text or content from the documents.

Corpus 130 could include a document database of searchable records. For example, corpus 130 could be part of a search engine infrastructure storing web pages, or simply storing links to web pages. In other embodiments, corpus 130 of documents could include a compilation of analyzable records; a Customer Relationship Management (CRM) system, electronic medical records (EMR) database, newspaper or magazine articles, text books, scientific papers, file system, peer-reviewed papers, product reviews, or other compilations.

Documents 110 in corpus 130 could comprise a homogenous or a heterogeneous mix of documents. For example, corpus 130 could simply include a homogenous set of on-line forum postings about a single topic, or review postings related of a product on a vendor website (e.g., possibly from Amazon® product review pages). Alternatively, documents 110 could include a heterogeneous mix of data types including text data, audio data, video data, image data, metadata, or other types or modalities of data. One should appreciate that each modality of data can be converted to other modalities if required as alluded to above. For example, audio data can be converted to text via ASR, or image data can be converted to a context or normalized concept represented as text based at least in part on OCR. Example techniques that can be suitability adapted for use in establishing a normalized concept are described in U.S. Pat. No. 8,315,849 to Gattani et al. titled “Selecting Terms in a Document” filed Apr. 9, 2010. In more preferred embodiments, corpus 130 has some form of unifying theme, possibly a specific topic, where corpus 130 can be constructed from a larger document database and where documents 110 are segregated according to normalized concepts or topics. Thus, corpus 130 can be considered, in some embodiments, a theme-specific corpus. Example documents 110 can include reviews, blogs, articles, books, emails, magazines, newspapers, news stories, financial articles, forum post, financial posts, political writing, advertisements, or other types of documents.

Document 110 can be considered an encoding of information that is preferably available in a digital format (e.g., text, audio, image, video, metadata, etc.). Documents 110 preferably comprise one or more document elements 115 representing actual information on which a sentiment analysis is based. Elements 115 of the document 110 can cover a broad spectrum of granularity. For example, an element 115 could include a single word in the document 110 or include a phrase, a sentence, a paragraph, or even the whole document. Further, elements 115 could include derived elements obtained by analyzing the document 110. A derived element could include a normalized concept or a context generated through analyzing content of a corresponding document 110 as referenced above. Example elements 115 include a word, an idiom, a phrase, a concept, a normalized concept, a language independent element, an item of metadata, or other quanta of information.

Root cause analysis engine 140 couples with corpus 130 of documents via one or more document interfaces 150, possibly operating via a web service (e.g., HTTP server, API, etc.). Interface 150 could include a query-based interface capable of accepting natural language queries or structured database queries. In some embodiments, interface 150 could simply include a file system interface through which documents 110 can be accessed on a computer system's storage device (e.g., hard drive, SSD, flash, RAID, NAS, SAN, etc.). Other example interfaces 150 that can be leveraged by root cause analysis engine 140 include a web site, a web page, an application program interface (API), a database interface, a mobile device, a tablet, a phablet, a smart phone, a search engine, a web crawler, a browser, or other type of interface through which analysis engine 140 can obtain information related to documents 110. For example, root cause analysis engine 140 could obtain document information as a CSV file, XML, HTML, rich text, JPEG, or other format from a document database.

Root cause analysis engine 140 is illustrated as a standalone server. However, it should be appreciated that its roles or responsibilities can be placed on any one or more computing devices with sufficient capability to manage the root cause analysis responsibilities. In some embodiments, root cause analysis engine 140 operates as a for-fee Internet-based service, possibly on a cloud-based server farm where it can offer its root-causes analysis services as a platform-as-a-service (PaaS), an infrastructure-as-a-service (IaaS), or a software-as-a-service (SaaS). In other embodiments, it can be distributed across one or more computing devices; a cell phone and computer for example. Regardless of the implementation of analysis engine 140, it is preferably configured to obtain information related to corpus 130 of documents.

One specific piece of information obtained by analysis engine 140 preferably includes sentiment 127 related to corpus 130 or documents 110. In the example shown, analysis engine 140 obtains sentiment 127 from sentiment analysis engine 125, which derives sentiment 127. Sentiment 127 can be derived according to one or more known techniques, or based on techniques yet to be discovered. One among many possible sentiment analysis techniques that could be suitably adapted for use includes those described in U.S. Pat. No. 8,041,669 to Nigam et al. titled “Topical Sentiments in Electronic Stored Communications”, filed on Dec. 15, 2010. Another example includes U.S. Pat. No. 8,396,820 to Rennie titled “Framework for generating sentiment data for electronic content”, filed Apr. 28, 2010. Still another example includes U.S. Pat. No. 8,166,032 to Sommer et al. titled “System and Method for Sentiment-based Text Classification and Relevancy Ranking”, filed Apr. 9, 2009. With respect to stock market, yet another example includes U.S. Pat. No. 7,966,241 to Nosegbe titled “Stock Method for Measuring and Assigning Precise Meaning to Market Sentiment”, filed Mar. 1, 2007. Yet further U.S. Pat. No. 7,930,302 to Bandaru et al. titled “Method and System for Analyzing User-Generated Content” filed Nov. 5, 2007 also discloses suitable techniques that can be leveraged for use with the inventive subject matter.

One should appreciate that sentiment 127 can be derived from corpus 130, elements 115, and documents 110 through numerous techniques. Thus, the inventive subject matter is considered to include selecting a sentiment analysis rules set based on elements 115. For example, should elements 115 include references to food or include an image that is recognized as related to food, sentiment analysis engine 125 can select a sentiment analysis rules set that would be more suitable for determining sentiment with respect to the concept or topic of “food”, possibly the algorithm discussed by Bandaru in U.S. Pat. No. 7,930,302.

Further, sentiment 127 can be associated with different objects in the system at different levels of granularity: a single element 115 in document 110, a document 110, across a plurality of documents, the corpus 130, or other association. In more preferred embodiments, sentiment 127 is at least associated with a topic (e.g., product, political view, stock, review, forum thread, etc.). Sentiment 127 can be represented as a value indicating positive sentiment, negative sentiment, neutral sentiment, or other values. For example, a single sentence in document 110 could be identified as having a positive sentiment by assigning the sentence a value of +3 based on analysis of elements 115 in the sentence, where another sentence might have a negative sentiment with a value of −1 based on the analysis of elements 115 in the second sentence. If the document only has the two sentences, the document sentiment could be the sum of sentence sentiments; +2 in for this example. One should keep in mind that such sentiments could relate to one or more specific concepts or topics. One should appreciate the inventive subject matter can include multiple scales or range of values to represent sentiment. All possible sentiment values are contemplated.

In some embodiments, sentiment 127 can be derived through the use of dictionary 120 of known elements, where each known element comprises a mapping or weighting to sentiment 127. Further, each known element can include a weighting that represents a possible contribution of the known element to a final sentiment value. For example in the case of an element 115 representing a word (i.e., elements 115 has a granularity of a word), the known element word “love” might have a high positive weight, while the known element word “like” might have a lower positive weight. Thus, each element 115 can be mapped, along with a weight if desired, to at least one of a positive sentiment value, negative sentiment value, or even a neutral sentiment value. In some embodiments, element 115 could represent a positive sentiment as well as a negative sentiment value depending on the associated context, concept, user, or other factors. For example, element 115 might have a positive sentiment value of +1 for a specific concept or topic and have a negative value of −1 for a different specific concept or topic. Other weighting values are also possible. For example, an exceptional word (e.g., a known element that has very rare frequency of use) could have a much greater magnitude, or neutral words could have a weight of 0. Although sentiment values include positive, negative, or neutral aspects, one should appreciate that the inventive subject matter includes other sentiment value types. Example additional sentiment types could include emotionality, subtlety, persuasiveness, obfuscation, nostalgia, or other types of sentiment.

Elements 115 can also map to concepts as previously discussed. In such cases, concepts can be mapped to sentiment values. Further, root causes 147 can comprise a mapping between derived concepts from corpus 130 and elements 115 within the corpus to sentiment values. Thus, the concepts within documents 110, sentiment 127, and root cause 147 can be considered a foundational triad from which numerous advantages flow as discussed below. An especially preferred mapping includes mapping root cause 147 to one or more emotions associated with the documents. In the example shown, sentiment 127 is represented as being mapped to an emotion. Sentiment 127 can be mapped to an emotion through various techniques. In some embodiments, sentiment 127 can include multiple values, possibly stored as a vector, where each value represents a possible dimension of the corresponding sentiment 127. A vector of values can be compared to known emotion signatures defined within a common attribute space. If the vector of values is substantially close to a known emotional signature of corresponding structure, then sentiment 127 can be considered to reflect the corresponding emotion. Such an approach is considered advantageous because it allows one to understand the nature of sentiment 127 and allows one to further differentiate possible drivers. For example, several individuals might have strong positive sentiment toward a topic or concept, say investing. A first person might have strong feelings of love for the hobby of investing while a second person might have strong feelings of greed for money. Although both people give rise to high positive sentiment, their emotional states are quite different, which could result in different root causes 147 for the concept of investing as related to corpus 130.

Interestingly, dictionary 120 of known elements can be considered dynamic in the sense that the weights of the known elements can change with time or with other factors. As time changes, use of a phrase or idiom might change, thus causing the weight of the associated known element to change. Further, the weight might reflect different cultural views, geographical regions, demographics, type of sentiment analysis, or other factors. The dynamic nature of dictionary 120 allows for providing one or more dictionaries, possibly for a fee, that have been adapted to reflect a perspective of interest. Further, offering access to different dictionaries 120 also provides for validating a sentiment from different perspectives. For example, a sentiment standards body that establishes how standards for generating sentiments their root causes could construct or maintain a reference dictionary through which various sentiment analysis providers can objectively validate or at least certify their sentiment analysis systems.

In view that sentiment 127 can be applied to more than one document 110, sentiment 127 could include an aggregate sentiment that includes a compilation of multiple sentiments across one or more documents 110. Further, sentiment 127 can include a plurality of sentiment values. Each value in sentiment 127 could represent a different facet or dimension of sentiment 127. In some embodiments, the sentiment values could include an average sentiment value, a distribution of sentiment values, a confidence level, or other statistical factors. Such an approach is considered advantageous when multiple sentiment analysis techniques can be run on documents 110 in corpus 130, or where a single technique is run but operates according to different policies or rules (e.g., cultural rule sets, demographic rule sets, etc.). The sentiment values can also reflect different sentiment dimensions that can impact sentiment 127. Example dimensions include demographic of a document user, demographic of a document provider, one or more topics in the documents, language, jurisdiction, culture, or other factors. Thus, one should appreciate that portions of corpus 130 can be analyzed based on various dimensions or selection criteria that results in sentiment 127 comprising a multi-valued sentiment.

Root cause analysis engine 140 is preferably configured to analyze elements 115 in corpus 130 with respect to sentiment 127 to generate at least one root cause 147 for sentiment 127. One should appreciate that root cause 147, and sentiment 127 for that matter, can be considered distinct manageable objects within the system, but could be related or linked together. Through comparing elements 115, possibly at different levels of granularity, to sentiments 127, root cause analysis engine 140 provides a view into causes, reasons, or drivers that appear to motivate sentiment 127. Root cause 147 provides valuable insight to those individuals that manage the topics associated with corpus 130. For example, a company marketing a product can determine what factors appear to be sentiment drivers for their products based on product reviews from Amazon or other vendor sites.

Root cause 147 can take on many different forms. In some embodiments, one or more of root cause 147 is associated with each sentiment value to allow users to see what gave rise to the specific sentiment 127. Therefore, in multi-valued sentiments, each sentiment value might have its own root cause 147 or even multiple root causes.

In the example shown, elements analyzer 141 represents a module within root cause analysis engine 140 and is configured or programmed to analyze elements 115 within corpus 130. Element analyzer 141 includes one or more rules sets that relate to the same topic as corpus 130 where the rules sets can govern how analyzer 141 indirectly extracts concepts from documents 110 within corpus 130. For example, a rules set can be related to the topic of banks. Analyzer 141 obtains the bank rule rules set and can apply the bank analysis rule sets to bank related corpus 130. The bank rules set can identify elements 115 that relate directly to a bank, or even a specific bank. Then, possibly based on a proximity analysis, analyzer 141 can identify concepts relating the bank's other services perhaps including fees, interest rates, employees, loans, lines of credit, or other concepts. If the same analysis were applied to a different bank, the results of extracted concepts would likely be different because the different bank would have a different corpus 130. One example technique for classifying concepts based on words that could suitably be adapted for use with the inventive subject matter includes U.S. Pat. No. 6,487,545 to Wical titled “Methods and Apparatus for Classifying Terminology Utilizing a Knowledge Catalog”, filed May 28, 1999.

Root cause (RC) analyzer 145 is also considered a module within root cause analysis engine 140 and is configured or programmed to take sentiment 127 and results from element analyzer 141 to determine root cause 147. RC analyzer 145 maps concepts from element analyzer 141 to one or more of sentiment 127 according to a root cause model. One should appreciate that RC analyzer 145 can also function according to multiple root cause models, even root cause models that are concept-specific or topic-specific. For example, when corpus 130 is associated with video game reviews, element analyzer 141 might function according a video game rules set that seeks to generate one or more video game concepts (e.g., character, story, genre, etc.). RC analyzer can then apply one or more video game root cause models, possibly models that are specific to the concepts, to determine what gave rise to sentiment 127. A more specific example might include a root cause model comprising a concept-specific look-up table that cross references elements 115 (e.g., a first index in a matrix) to sentiment 127 (e.g., a second index in the matrix) where the corresponding cell indicates a possible an a priori defined root cause. The root cause model could include multiple concept-specific look-up tables. All possible root cause models are contemplated.

Another acceptable technique for determining root cause 147 could include extracting information from corpus 130 based on a root cause model, and without regard to known words in corpus 130 or predefined features related to sentiment 127. The extracted information can then be used to determine which elements 115 from corpus 130 could have given rise to the sentiment 127. Such an approach is considered advantageous as it is considered to remove bias in determining why sentiment 127 was generated. In some embodiments, root cause 147 can be determined based on one or more root cause models applied to the corpus. For example, root cause engine 140 can search corpus 130 for elements 115 based on one or more algorithms, formulas, or patterns pertaining to a specific model. Root cause engine 140 could search corpus 130 for sentences having defined sentence structures according to the model. When sentences of interest are found, the features of the sentences (e.g., words, phrases, subject, verb, adjectives, adverbs, objects, etc.) can be further extracted and reviewed as indicated by element analyzer 141, which yields extracted concepts. One should appreciate that the sentence features can have multiple levels of granularity; phrase level, term level, word level, or other element level, for example. Root cause engine 140 can then apply one or more decision rules to the features to determine if the feature could represent root cause 147 according to the root cause model. The root cause model approach allows for the root cause engine to generate different types of root causes 147 by providing for variation in the model's algorithms, or variation in decision rules.

An astute reader will recognize that the root cause analysis can be decoupled from the sentiment analysis used to generate sentiment 127. Such an approach gives rise to providing a third party measure or validity of a sentiment analysis. Further, multiple root cause analyses operating based on different algorithms as intimated above can be conducted on a single sentiment 127 to provide better insight into the validity of sentiment 127. In a similar vein, root cause 147 can also include a confidence score associated with the root cause 147 where the confidence score could represent a statistical measure, error analysis, or other factors. Still further, the confidence score could also comprise a validity measure indicating how appropriately root cause 147 represents a sentiment driver for sentiment 127. For example, in an embodiment where the root causes analysis engine operates as a service (e.g., IaaS, SaaS, PaaS, etc.), periodically the service can submit a validity survey to third party individuals. The individuals can then rate the validity of the root cause analysis with respect to sentiment 127. Amazon's Mechanical Turk engine (see URL www.mturk.com/mturk/welcome) or Survey Monkey (see URL www.surveymonkey.com) could be adapted for such a use. The surveys can be constructed according to one or more root cause models as desired.

Root cause 147 of sentiment 127 can cover a broad spectrum of sentiment drivers. In some embodiments, root cause 147 comprises an indication of which element 115 in document 110 corresponds to a sentiment driver. For example, a sentence in document 110 might have a positive sentiment because the known element word “exquisite” is present in the sentence and is associated with a target topic of the sentence (e.g., noun, subject, direct object, indirect object, etc.). It is also contemplated that multiple root causes 147 can combine together in aggregate to form a sentiment driver. For example, root cause 147 could be attributed to a concordance of words in the documents 110 where each word has an associated frequency of appearance. The concordance in aggregate could be considered to have a sentiment signature or emotion signature that could be considered a sentiment driver. Other example root causes 147 can be based on a cluster of elements, a grouping of elements, a trend in drivers, a change in a sentiment metric, a ranking, a vector, an event, a concept, a cloud, a person, a demographic, a psychographic, or other factors.

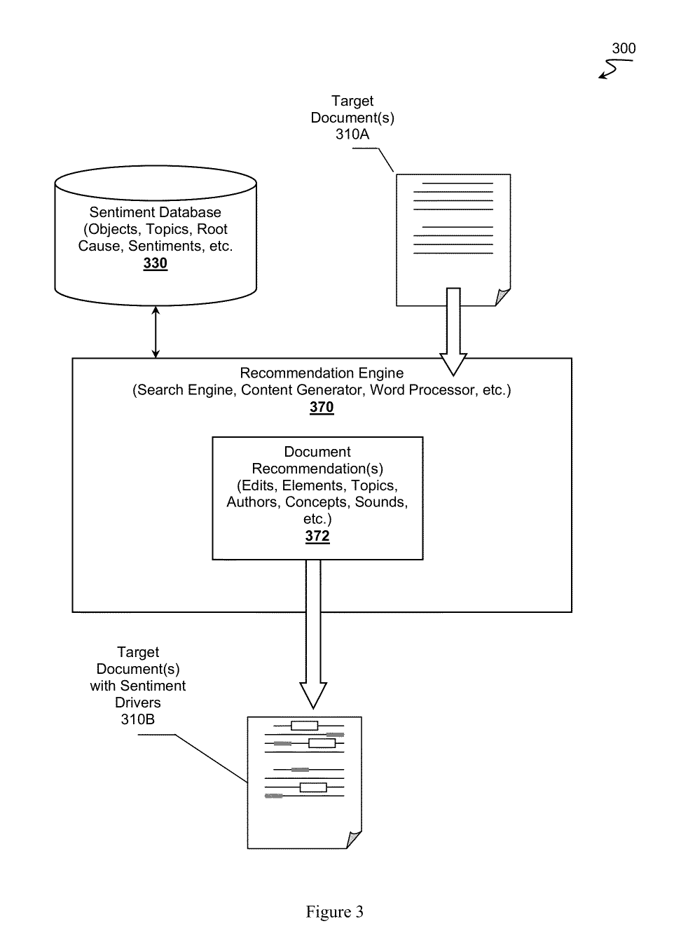

One interesting use of root cause 147 can include providing recommendations on changing a document, possibly via output device 170, so that it comprises sentiment drivers or root causes features so that an analysis of the document would generate a desired sentiment. Such a feature is discussed more fully with respect to FIG. 3 below.

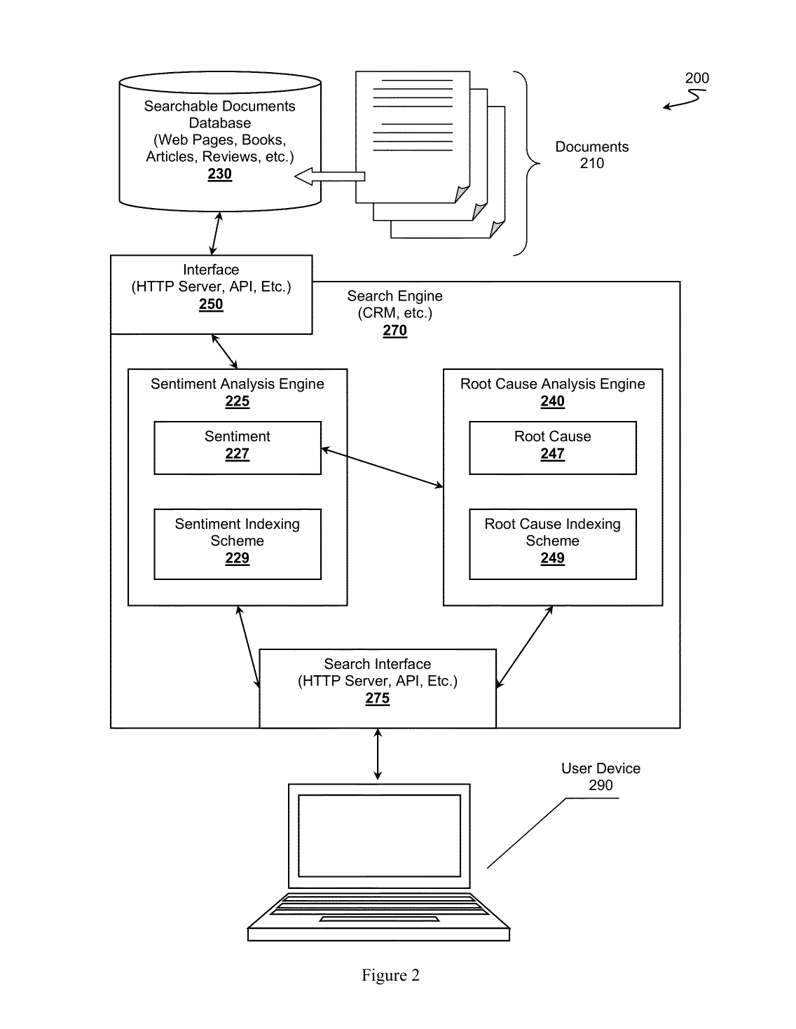

FIG. 2 illustrates another ecosystem 200 comprising search engine 270 capable of concept-based root cause analysis to aid in searching for or within documents 210. Search engine 270 can include searchable document database 230 storing a plurality of searchable documents 210. One should appreciate that database 230 can be local to search engine 270, distributed across multiple computing devices, or located across numerous websites throughout the world. In some embodiments, database 230 can simply store links to where documents 210 are located; using URLs, URIs, or other network addresses for links for example. Example documents 210 preferably stored in searchable document database 230 in digital format: web pages, a secured database of records, a publicly available database of records, a private database of records, EMR database, CRM records, emails, forum posts, video files, image files, audio files, text files, multi-media files, newspaper articles, magazine articles, advertisements, or other documents. Although the search engine 270 is represented as a publically accessible search engine (e.g., Google®, Yahoo!®, Ask®, Amazon, etc.), one should appreciate that the search engine 270 could be implemented as a for-fee service. For example, the search engine could operate as a CRM engine (e.g., SalesForce™) where documents 210 in database 230 include CRM records and where clients pay for use or pay a subscription fee to access the services of search engine 270.

In more preferred embodiments, search engine 270 includes one or more sentiment analysis engines 225 configured to derive sentiment 227, as discussed previously, with respect to one or more documents 210, possibly where sentiment 227 is associated with a topic or a concept. Sentiment analysis engine 270 can then index documents 210 in database 230 via one or more sentiment-based indexing schemes 229. Such an approach allows searchers (e.g., humans, computers, applications, etc.) to search for documents 210 related to sentiment 227 with respect to one or more topics or concepts. Searchers can access the search engine 270 via a search interface 275 (e.g., HTTP server, API, RPC, web service, etc.) through which the search engine 270 can present search results that satisfy a sentiment-based query submitted to the search engine 270.

Sentiment-based indexing scheme 229 can be quite diverse depending on the design goals of search engine 270. In some embodiments, indexing scheme 229 can comprise a mapping to an emotion or concept derived as discussed above. Documents 210 in the system be tagged or organized by associated sentiment-based emotions, according to topic, or combination. Thus, a searcher can submit a query similar to “Love Dogs”, for example, to search engine 270. Search engine 270 can then return documents 210 having high positive sentiment and relating to the topic of dogs. Further, the search results can be ranked or organized based on the degree of sentimentality associated with the documents in the result set. Indexing scheme 229 could also comprise mapping to sentiment values positive sentiment, negative sentiment, neutral sentiment, or other form of sentimentality. Similar to the emotion example, search results can be returned according to their sentiment values.

In more preferred embodiments, sentiment-based indexing scheme 229 integrates a document topic with sentiment 227, or even root cause 247. Such an approach allows for indexing document 210 through multiple sentiment dimensions as referenced previously in this document. Further, indexing scheme 229 can take into account the attributes of the searcher (e.g., preferences, demographics, etc.), which can aid the search engine 270 to determine which dimensionality of sentiment 227 are most relevant to the search. For example, a young adult might search for “sick video games” where the search engine interprets the word “sick” as meaning “hot”, “well liked”, “highly rated”, or other strong positive sentiment. However, the search engine could also interpret the word “sick” as having a strong negative sentiment if submitted by a searcher of a different demographic. In such situations, search engine 270 could map such sentiment queries to an intermediary abstract or normalized concept or emotion before a search is conducted.

The sentiment-based query can also take on many different forms. Preferred embodiments involving a human end-user, the query can include a natural language query. While in other embodiments, the actual query submitted to search engine 270 is derived from the user-submitted query where the actual query could include sentiment-based search parameters. In such scenarios, the actual query could include any combination of user-submitted keywords (e.g., text, images, sounds, etc.) and machine generated sentiment information. For example, the user-submitted query “Love Dogs” might become an XML data structure of the form “<SentimentValue>+10</SentimentValue> and (dog or canine)” where the search term “love” has been mapped to a sentiment value of 10, say on a scale of −10 (negative sentiment) to 10 (high positive sentiment).

As illustrated, search engine 270 can also include root cause analysis engine 240. In fact, some embodiments lack sentiment analysis engine 225 but still comprise root cause analysis engine 240. Root cause analysis engine 240 can obtain sentiment 227, possibly already stored in conjunction with documents 210 in database 230 and with an associated topic, or from internal or external sentiment analysis engine 225. Root cause analysis engine 240 can further conduct a root cause analysis of sentiment 227 with respect to documents 210 and topic to generate one or more root causes 247 as discussed previously. Root cause 247 can then be used to index documents 210 according to root cause indexing scheme 249.

Similar to sentiment-based indexing scheme 229, root cause indexing scheme 249 can also map to emotions. One should appreciate that root cause indexing scheme 249 allows for tagging or otherwise identifying documents 210 based on one or more sentiment drivers that are considered a reason for the documents to take on sentiment 227. Other mappings can include a mapping to an element, a word, a phrase, a concept, a normalized concept, an image, a person, an event, a sound, a topic derived from the document, or other root cause. Searchers can submit one or more queries to search engine 270 where the queries include a root cause-based query or, where a root cause-based query can be derived from the user-submitted query in a similar fashion as discussed above with respect to sentiment-based queries. Regardless of the form of the query, search engine 270 can return documents 210 satisfying the query and can rank the result set according to root cause 247, sentiment 227, topic, or other property.

Consider a scenario where a searcher wishes to identify documents having high positive sentiment where the root cause for the sentiment is “brand loyalty”. Such a scenario might be relevant to a marketing person of a famous brand (e.g., energy drink, car model, sports team, etc.). The searcher can submit a query to search engine 270 that could include a reference to the brand, a positive sentiment (e.g., <sentiment.gt.5 and sentiment.le.10> assuming a scale of 1 to 10), and a root cause (e.g., <root_cause=“Brand Loyalty”>). Search engine 270 returns a result set of documents 210 that reference the brand, have metadata indicating a positive sentiment, and have metadata indicating the sentiment was generated due to brand loyalty. Such an approach would be advantageous when generating potential advertising targeting consumers of documents 210.

In some embodiments, search engine 270 operates as a web crawler. The web crawler's direction or progress can be controlled through sentiment 227 or root causes 247. As the crawler operates, it can preferentially select which documents 210 to examine based on the sentiment or root cause features associated with the documents. For example, if the crawler examines two documents where one has a much higher positive sentiment, then the crawler can use links in that document to find additional document before using links from the less positive document. Further, in cases where documents are annotated with sentiment or root cause information, the crawler can pursue documents satisfying sentiment or root cause-based crawling criteria.

In view of the discussion with FIG. 2, the inventive subject matter is considered to include systems and methods of searching for documents based on root causes or drivers that give rise to sentiment. Contemplate claims include the claims listed in Table 1.

TABLE 1
Possible Root-Cause Search Engine Claims.

| Claim # | Text |
|---|---|
| 1. | A search engine comprising: |
| | a database storing a plurality of searchable documents; |
| | a sentiment analysis engine coupled with the database and configured to: |
| | derive a sentiment related to at least some of the documents according to a |
| | topic, and |
| | index the at least some of the documents in the database according to a |
| | sentiment-based indexing scheme; and |
| | a search interface coupled with the database and configured to present |
| | search results comprising documents from the database that satisfy a |
| | sentiment-based query submitted to the database. |
| 2. | The search engine of claim 1, wherein the sentiment-based indexing scheme |
| | comprises a mapping to emotion. |
| 3. | The search engine of claim 1, wherein the sentiment-based indexing scheme |
| | comprises a mapping to a least one of the following: a positive sentiment, a negative |
| | sentiment, and neutral sentiment. |
| 4. | The search engine of claim 1, wherein the sentiment-based indexing scheme |
| | comprises a mapping to the topic derived from the at least some of the documents. |
| 5. | The search engine of claim 1, wherein the sentiment-base query comprises a natural |
| | language query. |
| 6. | The search engine of claim 1, wherein the sentiment-based query is constructed from |
| | a user-submitted query. |
| 7. | The search engine of claim 1, wherein the documents comprise at least one of the |
| | following: web pages, a secured database of records, a publicly available data of |
| | records, and a private database of records. |
| 8. | The search engine of claim 1, wherein the documents comprise Customer |
| | Relationship Management (CRM) records. |
| 9. | The search engine of claim 1, wherein the documents comprise at least one of the |
| | following: emails, forum posts, video files, image files, audio files, text files, multi- |
| | media files, newspaper articles, magazine articles, and advertisements. |
| 10. | The search engine of claim 1, further comprising a root cause analysis engine |
| | configured to: |
| | obtain the sentiment related to the at least some of the documents according |
| | to the topic, |
| | derive a root cause associated with the sentiment, and |
| | index the at least some of the documents in the database according to a root |
| | cause-based indexing scheme. |
| 11. | The search engine of claim 10, wherein the search interface is further configured to |
| | present search results comprising documents from the database that satisfy a root |
| | cause-based query submitted to the database. |
| 12. | A search engine comprising: |
| | a database storing a plurality of searchable documents; |
| | a root cause analysis engine coupled with the database and configured to: |
| | obtain a sentiment related to at least some of the documents according to a |
| | topic, |
| | derive a root cause associated with the sentiment, and |
| | index the at least some of the documents in the database according to a root |
| | cause-based indexing scheme; and |
| | a search interface coupled with the database and configured to present search |
| | results comprising documents from the database that satisfy a sentiment-based query |
| | submitted to the database. |
| 13. | The search engine of claim 12, wherein the root cause-based indexing scheme |
| | comprises a mapping to emotion. |
| 14. | The search engine of claim 12, wherein the root cause-based indexing scheme |
| | comprises a mapping to a least one of the following: a element, a word, a phrase, a |
| | concept, a normalized concept, an image, a person, an event, and a sound. |
| 15. | The search engine of claim 12, wherein the root cause-based indexing scheme |
| | comprises a mapping to the topic derived from the at least some of the documents. |
| 16. | The search engine of claim 12, wherein the root cause-base query comprises a |
| | natural language query. |
| 17. | The search engine of claim 12, wherein the root cause-based query is constructed |
| | from a user-submitted query. |
| 18. | The search engine of claim 12, wherein the documents comprise web pages. |
| 19. | The search engine of claim 12, wherein the documents comprise Customer |
| | Relationship Management (CRM) records. |
| 20. | The search engine of claim 12, wherein the documents comprise at least one of the |
| | following: emails, forum posts, video files, image files, audio files, text files, multi- |
| | media files, newspaper articles, magazine articles, and advertisements. |
| 21. | The search engine of claim 12, further comprising a sentiment analysis engine |
| | configured to: |
| | derive the sentiment related to the at least some of the documents according |
| | to the topic, and |
| | index the at least some of the documents in the database according to a |
| | sentiment-based indexing scheme. |
| 22. | The search engine of claim 21, wherein the search interface is further configured to |
| | present search results comprising documents from the database that satisfy a root |
| | cause-based query submitted to the database. |

FIG. 3 illustrates another possible ecosystem comprising sentiment-based recommendation system 300. Recommendation system 300 is configured to leverage sentiment or root cause and provide insight into how an input document 310A can be updated or otherwise modified to better conform with a desired sentiment or with a root cause. The illustrated system 300 includes a sentiment database 330 configured to store sentiment objects where each object represents a data structure comprising a sentiment associated with a topic. In some embodiments, the sentiment object is associated with one or more source documents (e.g., document within a corpus directed to the topic) from which the sentiment was derived. The sentiment object can comprise a wealth of information related to the sentiment possibly including topics, geographic location, time stamps, document type, documents, or other attributes. For example, the sentiment object could include root causes for a sentiment value, where the root causes might be different depending demographics or other factors as discussed previously.

Recommendation system 300 also includes recommendation engine 370 that receives a target document 310A for analysis. Target document 310A can be obtained through different techniques depending on the nature of recommendation engine 370. In embodiments where recommendation engine 370 comprises a word processing program, engine 370 has immediate access to document 310A in the memory or on the file system of the computer executing the word processing program. Recommendation engine 370 can conduct a recommendation analysis in substantially real-time as document 310A is edited. In embodiments where the recommendation engine 370 is an on-line content submission tool (e.g., search engine, on-line community, forum interface, etc.), engine 370 receives document 310A over a network (e.g., Internet, WAN, LAN, VPN, etc.). Regardless of how recommendation engine receives document 310A, document 310A can be of nearly any form including a blog, an article, a review, an advertisement, an image, a video, an audio file, a text file, a web page, or other type of document.

Recommendation engine 370 analyzes target document 310A to determine one or more topics disclosed in target document 310A as discussed above. Through the use of the topic, recommendation engine 370A can identify one or more sentiment objects that relate to the topic using the techniques disclosed above, possibly based on a topic index, type of document, author, or other factor. Upon finding relevant sentiment objects, recommendation engine 370 can generate one or more document recommendations 372 comprising sentiment drivers for inclusion or incorporation into target document 310A, where the sentiment drivers are determined from root causes bound to the sentiment objects. The sentiment drivers preferably represent document format specific features that can be integrated into target document 310A (e.g., an element, a word, a phrase, a picture, a person, an event, a concept, a normalized concept, a sound, metadata, etc.) as presented by target document 310B. Target document 310B will have the characteristics associated with a desired sentiment. In yet more preferred embodiments, a user can filter or otherwise select which sentiment objects should be used to generate the sentiment drivers.

Recommendation engine 370 can present recommendations 372 via one or more output device, possibly through a browser or via a word processing program. Recommendations 372 can include highlighted portions of target document 310B, an update to the document, a deletion from the document, an addition, or other modification. One should appreciate that the sentiment drivers allow a user to better conform their target documents to a desired sentiment. Such an approach is considered advantageous when creating marketing materials, advertisements, reviews, articles, or other documents for public consumption.

In some embodiments, recommendation engine 370 comprises a search engine. In such cases, a query to the search engine can be considered a document, albeit a small one. The search engine can then recommend changes to the query or other types of queries to better conform with a desired sentiment or root cause-based search.

In view of the discussion with respect to FIG. 3, one should appreciate that the inventive subject matter is also considered to include a recommendation system capable of offering document editors insight into how to amend their documents to conform to a desired sentiment or to include a root cause or sentiment driver. Table 2 lists a possible set of claims related to a recommendation system.

TABLE 2
Possible Sentiment or Root-Cause Recommendation System Claims

| Claim # | Text |
|---|---|
| 1. | A sentiment-based recommendation system comprising: |
| | a sentiment database storing a plurality of sentiment objects, each sentiment object |
| | representative of a sentiment related to a set of documents and a topic, and having at |
| | least one root cause for the sentiment; and |
| | a recommendation engine coupled with the sentiment database and configured to: |
| | receive a target document related to a target topic, |
| | identify at least one sentiment object in the sentiment database related to the |
| | target topic, |
| | generate a document recommendation comprising sentiment drivers for the |
| | target document derived from root causes of the at least one sentiment object, |
| | and |
| | configure an output device to present the document recommendation. |
| 2. | The system of claim 1, wherein the recommendation engine comprises a word |
| | processor. |
| 3. | The system of claim 1, wherein the recommendation engine comprises an on-line |
| | content submission tool. |
| 4. | The system of claim 1, wherein the target document comprises at least one of the |
| | following: a blog, an article, a review, an advertisement, an image, a video, an audio |
| | file, and a web page. |
| 5. | The system of claim 1, wherein the sentiment drivers comprises at least one of the |
| | following: a element, a word, a phrase, a picture, a person, an event, a concept, a |
| | normalized concept, and a sound. |
| 6. | The system of claim 1, wherein the document recommendation comprises highlighted |
| | portions of the target document. |
| 7. | The system of claim 1, wherein the document recommendations comprises at least |
| | one of the following: an update, a deletion, an addition, and a modification. |
| 8. | The system of claim 1, wherein the document recommendation comprises metadata. |
| 9. | The system of claim 1, wherein the recommendation engine comprises a search |
| | engine. |
| 10. | The system of claim 9, wherein the target document comprises a query to the search |
| | engine. |
| 11. | The system of claim 10, wherein the document recommendation comprises |
| | suggested changes to the query. |

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . . and N, the text should be interpreted as requiring only one element from the group, not A plus N, or B plus N, etc.

What is claimed is:

1. A sentiment root-cause analysis system comprising:
a document interface configured to obtain a corpus of documents, each document comprising elements; and
a root cause analysis engine coupled with the document interface and configured to
obtain a sentiment from the corpus and associate it with a topic related the corpus,
analyze elements in the corpus to generate at least one root cause of the sentiment, and
configure an output device to present the root cause.

2. The system of claim 1, wherein the document interface comprises at least one of the following a web site, a web page, an application program interface (API), a database interface, a mobile device, a tablet, a smart phone, a search engine, a web crawler, and a browser.

3. The system of claim 1, wherein the corpus of documents comprises at least one of the following types of data text, audio, video, image, and metadata.

4. The system of claim 1, wherein the corpus of documents comprises at least one of the following reviews, blogs, articles, books, emails, magazines, newspapers, news stories, financial articles, and forum posts.

5. The system of claim 1, wherein the sentiment is associated with at least one document in the corpus.

6. The system of claim 5, wherein the sentiment comprises an aggregate sentiment across the corpus.

7. The system of claim 1, wherein the sentiment comprises a plurality of sentiment values.

8. The system of claim 7, wherein the sentiment values correspond to at least one of a sentence in the corpus and a document in the corpus.

9. The system of claim 7, wherein the sentiment values correspond to sentiment dimensions.

10. The system of claim 7, wherein the sentiment comprises a multi-valued sentiment.

11. The system of claim 7, wherein the root cause comprises multiple root causes mapped to some members of the plurality of sentiment values.

12. The system of claim 1, further comprising a dictionary database storing a priori known elements, each known element comprising a mapping to a sentiment value weight.

13. The system of claim 12, wherein the known elements map to a positive sentiment value weight.

14. The system of claim 12, wherein the known elements map to a negative sentiment value weight.

15. The system of claim 12, wherein the known elements map to a neutral sentiment value weight.

16. The system of claim 1, wherein the at least one root cause of the sentiment comprises a mapping between derived concepts and elements of the corpus.

17. The system of claim 1, wherein the at least one root cause comprises an emotion derived from the sentiment.

18. The system of claim 1, wherein the elements comprises at least one of the following a word, an idiom, a phrase, a concept, a normalized concept, a language independent element, and an item of metadata.

19. The system of claim 1, wherein the at least one root causes includes multiple root causes.

20. The system of claim 19, wherein the multiple root causes comprises at least one of the following a cluster, a grouping, a trend, a change in a sentiment metric, a ranking, a vector, an event, a concept, a cloud, a person, a demographic, and a psychographic.

21. The system of claim 1, wherein the root cause analysis engine is communicatively coupled with a customer relationship management (CRM) system.

22. The system of claim 21, wherein the corpus of documents comprises CRM data records.

23. The system of claim 1, wherein the at least one root causes comprises a confidence score.

24. The system of claim 23, wherein the confidence score comprises a validity measure.

25. The system of claim 23, wherein the root cause analysis engine is further configured to validate the at least one root cause according to a root cause model.

26. The system of claim 1, wherein the at least one root cause comprises a recommendation on content changes to at least one document.
